(19) United States
(12) Patent Application Publication
(10) Pub. No.: US 2022/0405441 A1
(43) Pub. Date: Dec. 22, 2022

(54) DESIGNING A STRUCTURAL PRODUCT INCLUDING STRUCTURAL ANALYSIS AND POST-PROCESSING

(71) Applicant: The Boeing Company, Chicago, IL (US)

(72) Inventors: Chandrashekar Subraya, Bellevue, WA (US); Venkata Narasimha Ravi Udali, Bothell, WA (US); Samir Abad, Bellevue, WA (US)

(21) Appl. No.: 17/693,951

(22) Filed: Mar. 14, 2022

Related U.S. Application Data
(60) Provisional application No. 63/202,646, filed on Jun. 18, 2021.

(51) Int. Cl. G06F 30/23; G06F 30/10

(52) U.S. Cl. CPC G06F 30/23; G06F 30/10; G06F 2111/10

(57) ABSTRACT

A method is provided for designing a structural product. The method includes accessing a finite element method (FEM) model in which the structural product is represented by a mesh of elements with respective nodal points and nodal datasets, indexed by element identifier, and including part identifiers of the component parts to which the elements belong. The method includes accessing results from a finite element analysis of the FEM model that indicate internal loads and deflections on the structural product under an external load. The results are also indexed by element identifier. A part identifier for a component part is identified; and element identifiers of the elements for the component part, and whose nodal datasets include the part identifier, are determined. The internal loads and deflections on the component part are extracted, and post-processed to determine an effect of the external load on the component part.

### CROSS-REFERENCE TO RELATED APPLICATION(S)

This application claims the benefit of and priority to U.S. Provisional Patent Application No. 63/202,646, filed Jun. 18, 2021, entitled Designing a Structural Product Including Structural Analysis and Post-Processing, the content of which is incorporated herein by reference in its entirety.

### TECHNOLOGICAL FIELD

The present disclosure relates generally designing a structural product, and in particular, to designing a structural product including structural analysis and post-processing data produced from the analysis.

### BACKGROUND

Numerical modeling and analysis technology is an important tool in the design and verification of many engineered structural products and the structural components of which they are composed. One common computer-based numerical modeling and analysis technique is finite element method (FEM) modeling and analysis. In accordance with various numerical modeling analysis techniques, computer models may define a working environment in terms of geometry, elements, properties, loads, constraints and the like, and can thus be solved and analyzed to determine structural integrity of an engineered structural product within that working environment, for example. Through numerical modeling and analysis and in particular finite element analysis, it may be possible to break a complex system down into a manageable (finite) number of elements (e.g., a curve drawn as a series of steps). These computer models and their analysis may be used for several purposes, such as to help determine the behavior of a new airplane product design under various load environments.

The process for modeling an analysis of a structural product generally includes development of an appropriate computer model of the structural product, such as FEM model in which the structural product is represented by a mesh of elements. An analysis of the structural product is then performed from the numerical model to produce data, and data produced from the analysis is then post-processed such as to verify its validity, perform additional analyses and the like. Existing post-processing techniques for component parts of a structural product such as an aircraft often involves extracting the data for the component parts, organizing and then evaluating the data. This is a time consuming task since the data for all of the elements needs to similarly post-processed.

It would therefore be desirable to have a system and method that takes into account at least some of the issues discussed above, as well as other possible issues.

### BRIEF SUMMARY

Example implementations of the present disclosure are directed to designing a structural product, and in particular, to designing a structural product including structural analysis and post-processing data produced from the analysis. Some existing techniques for post-processing data standardize the element and node numbering sequence, but this numbering depends on the specific analysis being performed. Example implementations of the present disclosure provide a more generic post-processing technique in which datasets of the elements in the computer model include part identifiers of the component parts to which the elements belong. These part identifiers may be mapped to element identifiers, which may then be used to extract the analysis results for post-processing. In this manner, example implementations of the present disclosure may more quickly identify the results to be extracted for post-processing.

The present disclosure thus includes, without limitation, the following example implementations.

Some example implementations provide an apparatus for designing a structural product that includes component parts, the apparatus comprising a memory configured to store computer-readable program code; and processing circuitry configured to access the memory, and execute the computer-readable program code to cause the apparatus to at least: access a finite element method (FEM) model in which the structural product is represented by a mesh of elements with respective nodal points and nodal datasets, the elements indexed by element identifier, and the nodal datasets of the elements including part identifiers of the component parts to which the elements belong; access results from a finite element analysis of the FEM model that indicate internal loads and deflections on the structural product at the respective nodal points when the structural product is under an external load, and the results are also indexed by element identifier; identify a part identifier for a component part of the structural product; determine element identifiers of the elements for the component part, and whose nodal datasets include the part identifier; extract the internal loads and deflections on the component part from the results, and using the element identifiers; and post-process the internal loads and deflections on the component part to determine an effect of the external load on the component part.

Some example implementations provide a method of designing a structural product that includes component parts, the method comprising accessing a finite element method (FEM) model in which the structural product is represented by a mesh of elements with respective nodal points and nodal datasets, the elements indexed by element identifier, and the nodal datasets of the elements including part identifiers of the component parts to which the elements belong; accessing results from a finite element analysis of the FEM model that indicate internal loads and deflections on the structural product at the respective nodal points when the structural product is under an external load, and the results are also indexed by element identifier; identifying a part identifier for a component part of the structural product; determining element identifiers of the elements for the component part, and whose nodal datasets include the part identifier; extracting the internal loads and deflections on the component part from the results, and using the element identifiers; and post-processing the internal loads and deflections on the component part to determine an effect of the external load on the component part.

Some example implementations provide a computer-readable storage medium for designing a structural product that includes component parts, the computer-readable storage medium being non-transitory and having computer-readable program code stored therein that, in response to execution by processing circuitry, causes an apparatus to at least access a finite element method (FEM) model in which the structural product is represented by a mesh of elements with respective nodal points and nodal datasets, the elements indexed by element identifier, and the nodal datasets of the elements including part identifiers of the component parts to which the elements belong; access results from a finite element analysis of the FEM model that indicate internal loads and deflections on the structural product at the respective nodal points when the structural product is under an external load, and the results are also indexed by element identifier; identify a part identifier for a component part of the structural product; determine element identifiers of the elements for the component part, and whose nodal datasets include the part identifier; extract the internal loads and deflections on the component part from the results, and using the element identifiers; and post-process the internal loads and deflections on the component part to determine an effect of the external load on the component part.

These and other features, aspects, and advantages of the present disclosure will be apparent from a reading of the following detailed description together with the accompanying figures, which are briefly described below. The present disclosure includes any combination of two, three, four or more features or elements set forth in this disclosure, regardless of whether such features or elements are expressly combined or otherwise recited in a specific example implementation described herein. This disclosure is intended to be read holistically such that any separable features or elements of the disclosure, in any of its aspects and example implementations, should be viewed as combinable unless the context of the disclosure clearly dictates otherwise.

It will therefore be appreciated that this Brief Summary is provided merely for purposes of summarizing some example implementations so as to provide a basic understanding of some aspects of the disclosure. Accordingly, it will be appreciated that the above described example implementations are merely examples and should not be construed to narrow the scope or spirit of the disclosure in any way. Other example implementations, aspects and advantages will become apparent from the following detailed description taken in conjunction with the accompanying figures which illustrate, by way of example, the principles of some described example implementations.

### BRIEF DESCRIPTION OF THE FIGURE(S)

Having thus described example implementations of the disclosure in general terms, reference will now be made to the accompanying figures, which are not necessarily drawn to scale, and wherein:

FIG. 1 illustrates one type of vehicle, namely, an aircraft that may benefit from example implementations of the present disclosure;

FIG. 2 illustrates an aircraft manufacturing and service method, according to some example implementations;

FIG. 3 illustrates a computer-aided design (CAD) model of a stow bin of an aircraft, and FIG. 4 illustrates a corresponding finite element method (FEM) model, according to some example implementations;

FIG. 5 illustrates the stow bin, and its component parts that may have respective, standardized part identifiers, according to some example implementations;

FIGS. 6A, 6B, 6C, 6D and 6E are flowcharts illustrating various steps in a method of designing a structural product that includes component parts, according to example implementations; and

FIG. 7 illustrates an apparatus according to some example implementations.

### DETAILED DESCRIPTION

Some implementations of the present disclosure will now be described more fully hereinafter with reference to the accompanying figures, in which some, but not all implementations of the disclosure are shown. Indeed, various implementations of the disclosure may be embodied in many different forms and should not be construed as limited to the implementations set forth herein; rather, these example implementations are provided so that this disclosure will be thorough and complete, and will fully convey the scope of the disclosure to those skilled in the art. Like reference numerals refer to like elements throughout.

Unless specified otherwise or clear from context, references to first, second or the like should not be construed to imply a particular order. A feature described as being above another feature (unless specified otherwise or clear from context) may instead be below, and vice versa; and similarly, features described as being to the left of another feature else may instead be to the right, and vice versa. Also, while reference may be made herein to quantitative measures, values, geometric relationships or the like, unless otherwise stated, any one or more if not all of these may be absolute or approximate to account for acceptable variations that may occur, such as those due to engineering tolerances or the like.

As used herein, unless specified otherwise or clear from context, the “or” of a set of operands is the “inclusive or” and thereby true if and only if one or more of the operands is true, as opposed to the “exclusive or” which is false when all of the operands are true. Thus, for example, “[A] or [B]” is true if [A] is true, or if [B] is true, or if both [A] and [B] are true. Further, the articles “a” and “an” mean “one or more,” unless specified otherwise or clear from context to be directed to a singular form. Furthermore, it should be understood that unless otherwise specified, the terms “data,” “content,” “digital content,” “information,” and similar terms may be at times used interchangeably.

Example implementations of the present disclosure relate generally to vehicular engineering and, in particular, to one or more of the design, construction, operation or use of vehicles. As used herein, a vehicle is a machine designed as an instrument of conveyance by land, water or air. A vehicle designed and configurable to fly may at times be referred to as an aerial vehicle, an aircraft or the like. Other examples of suitable vehicles include any of a number of different types of ground vehicles (e.g., motor vehicles, railed vehicles), watercraft, amphibious vehicles, spacecraft and the like.

A vehicle generally includes a basic structure, and a propulsion system coupled to the basic structure. The basic structure is the main supporting structure of the vehicle to which other components are attached. The basic structure is the load-bearing framework of the vehicle that structurally supports the vehicle in its construction and function. In various contexts, the basic structure may be referred to as a chassis, an airframe or the like.

The propulsion system includes one or more engines or motors configured to power one or more propulsors to generate propulsive forces that cause the vehicle to move. A propulsor is any of a number of different means of converting power into a propulsive force. Examples of suitable propulsors include rotors, propellers, wheels and the like. In some examples, the propulsion system includes a drivetrain configured to deliver power from the engines/motors to the propulsors. The engines/motors and drivetrain may in some contexts be referred to as the powertrain of the vehicle.

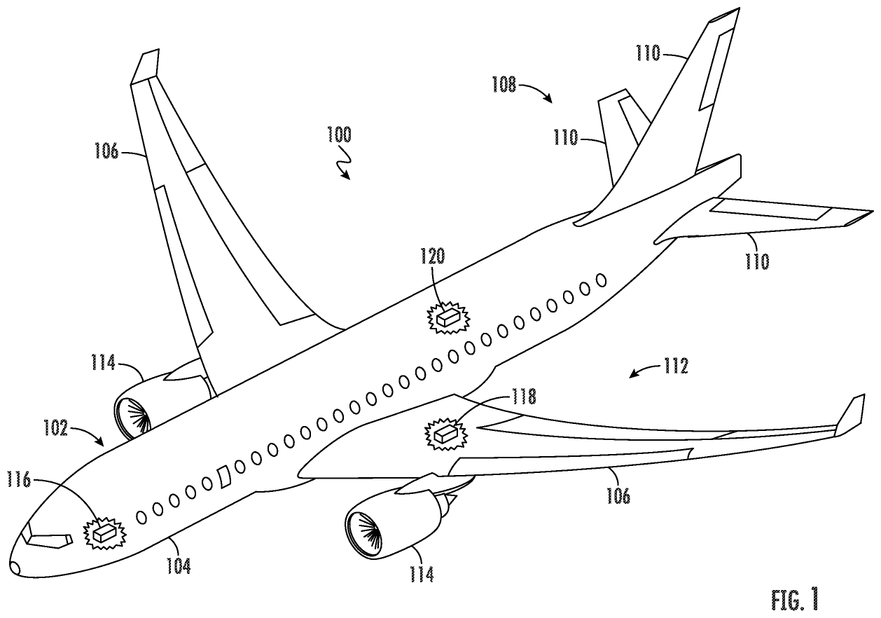

FIG. 1 illustrates one type of vehicle, namely, an aircraft 100 that may benefit from example implementations of the present disclosure. As shown, the aircraft includes a basic structure with an airframe 102 including a fuselage 104. The airframe also includes wings 106 that extend from opposing sides of the fuselage, an empennage or tail assembly 108 at a rear end of the fuselage, and the tail assembly includes stabilizers 110. The aircraft also includes a plurality of high-level systems 112 such as a propulsion system. In the particular example shown in FIG. 1, the propulsion system includes two wing-mounted engines 114 configured to power propulsors to generate propulsive forces that cause the aircraft to move. In other implementations, the propulsion system can include other arrangements, for example, engines carried by other portions of the aircraft including the fuselage and/or the tail. As also shown, the high-level systems may also include an electrical system 116, hydraulic system 118 and/or environmental system 120. Any number of other systems may be included.

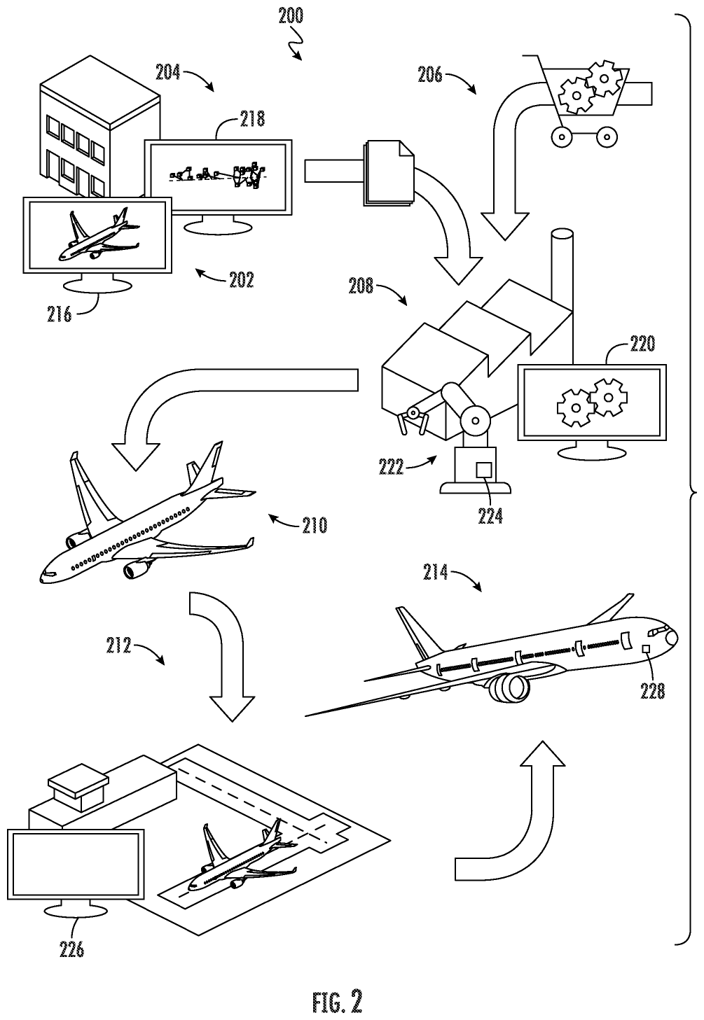

As explained above, example implementations of the present disclosure relate generally to vehicular engineering and, in particular, to one or more of the design, construction, operation or use of vehicles such as aircraft 100. Thus, referring now to FIG. 2, example implementations may be used in the context of an aircraft manufacturing and service method 200. During pre-production, the example method may include specification and design 202 of the aircraft, manufacturing sequence and processing planning 204 and material procurement 206. During production, component and subassembly manufacturing 208 and system integration 210 of the aircraft takes place. Thereafter, the aircraft may go through certification and delivery 212 in order to be placed in service 214. While in service by an operator, the aircraft may be scheduled for maintenance and service (which may also include modification, reconfiguration, refurbishment or the like).

Each of the processes of the example method 200 may be performed or carried out by a system integrator, third party and/or operator (e.g., customer). For the purposes of this description, a system integrator may include for example any number of aircraft manufacturers and major-system subcontractors; a third party may include for example any number of vendors, subcontractors and suppliers; and an operator may include for example an airline, leasing company, military entity, service organization or the like.

As will also be appreciated, computers are often used throughout the method 200; and in this regard, a “computer” is generally a machine that is programmable to programmed to perform functions or operations. The method as shown makes use of a number of example computers. These computers include computers 216, 218 used for the specification and design 202 of the aircraft, and the manufacturing sequence and processing planning 204. The method may also make use of computers 220 during component and subassembly manufacturing 208, which may also make use of computer numerical control (CNC) machines 222 or other robotics that are controlled by computers 224. Even further, computers 226 may be used while the aircraft is in service 214, as well as during maintenance and service; and as suggested in FIG. 1, the aircraft may itself include one or more computers 228 as part of or separate from its electrical system 116.

A number of the computers 216-228 used in the method 200 may be co-located or directly coupled to one another, or in some examples, various ones of the computers may communicate with one another across one or more computer networks. Further, although shown as part of the method, it should be understood that any one or more of the computers may function or operate separate from the method, without regard to any of the other computers. It should also be understood that the method may include one or more additional or alternative computers than those shown in FIG. 2.

Example implementations of the present disclosure may be implemented throughout the aircraft manufacturing and service method 200, but are particularly well suited for implementation during pre-production. In this regard, some example implementations provide a computer 216 for designing a structural product such as aircraft 100 that includes component parts. The computer is configured to access a finite element method (FEM) model in which the structural product is represented by a mesh of elements with respective nodal points and nodal datasets, the elements indexed by element identifier, and the nodal datasets of the elements including part identifiers of the component parts to which the elements belong.

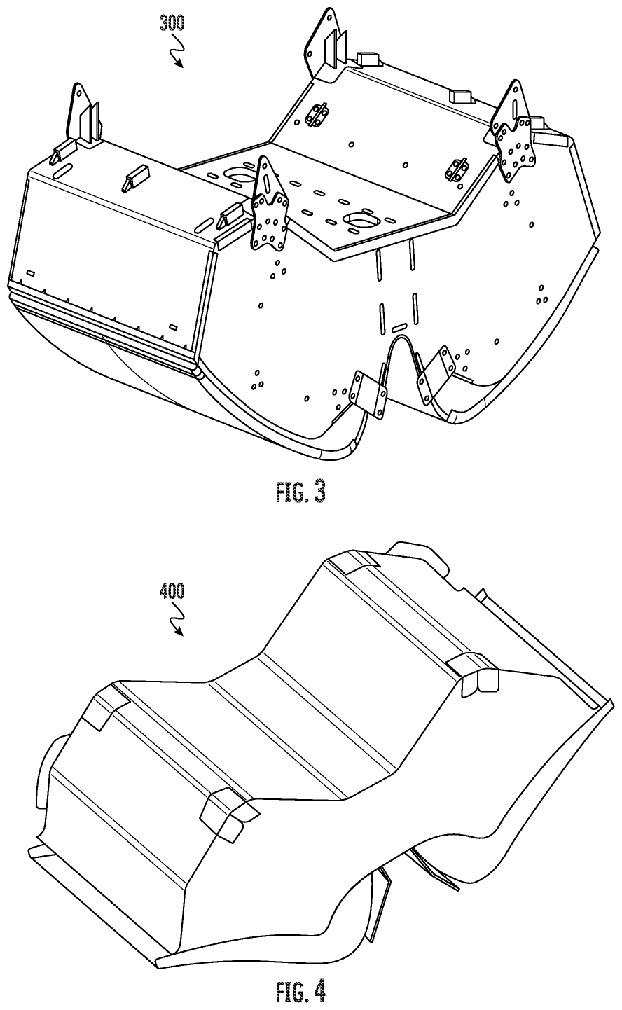

The FEM model may be produced in any of a number of different manners, such as by the computer 216 or another computer used in the method 200. In some examples, the computer may produce the FEM model from another computer model such as a computer-aided design (CAD) model of the structural product. FIG. 3 illustrates a CAD model 300 of a stow bin of an aircraft such as aircraft 100, and FIG. 4 illustrates a corresponding FEM model 400 of the stow bin, according to some example implementations. In both models, the component parts of the stow bin may be distinguished in a number of different manners such as by color.

The part identifiers of the component parts may be defined in a number of different manners to facilitate their use in post-processing. In some examples, a standard naming convention may be used for types of component parts. This standard name or part identifier may be used to identify that component part in a FEM model, and subsequently find the element identifiers and results for those elements from the finite element analysis. Standardized part identifiers may also be used to identify the component parts in a number of different computer models (e.g., CAD, FEM) to facilitate their organization for further analysis and documentation.

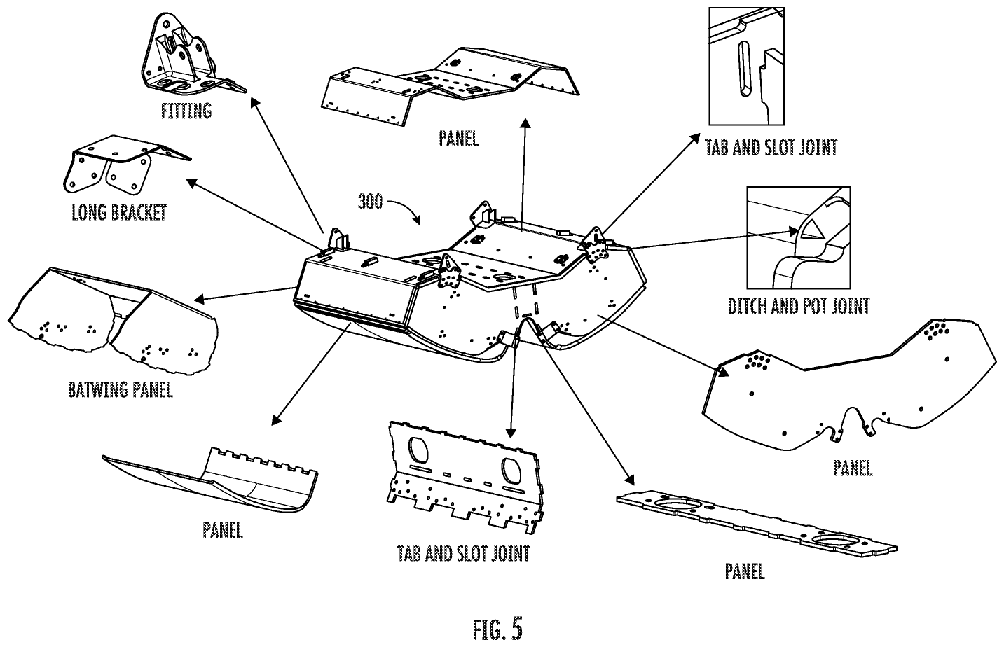

The standard naming convention in some examples follows a unique prefix on the property name followed by an underscore character (“_”), and a user defined suffix describing the component part. The following are a number more particular examples:
Comp1_XXXX, Comp1_YYYY, Comp1_ZZZZ, . . .
Comp2_XXXX, Comp2_YYYY, Comp2_ZZZZ, . . .
Comp3_XXXX, Comp3_YYYY, Comp3_ZZZZ, . . .
   The post-processing of the results for the Comp1's may use an analysis template that is unique to the type of the component part, as described in greater detail below. Likewise, the results for the Comp2's and Comp3's may use respective analysis templates that are unique to their types of component parts. FIG. 5 continues the example of the stow bin 300, and further illustrates its component parts including a number of panels, tab and slot (TAS) joints and ditch and pot (DAP joints. In this example, the component parts that may have part identifiers similar to the following:

| | | |
|---|---|---|
| Panel_Endblade | TAS_EB-SB | DAP_Endblade |
| Panel_PSU | TAS_PSU | DAP_PSU |
| Panel_Batwing | TAS_Batwing | DAP_Batwing |
| Panel_Face | TAS_Face | DAP_Face |

In examples in which the computer 216 is responsible for producing the FEM model, the computer may benefit from commercially-available software tools. Examples of suitable software tools include computer-aided design (CAD) systems, such as CATIA, SolidWorks or the like, available from Dassault Systèmes S.A. of Vélizy-Villacoublay, France. Other examples of suitable software tools include ABAQUS CAE available from Simulia (a subsidiary of Dassault Systemes); Altair Hypermesh, available from Altair Engineering, Inc. of Troy, Mich.; PATRAN, available from MSC Software Corporation of Newport Beach, Calif.; the ANSYS software suite, available from ANSYS, Inc. of Canonsburg, Pa.; HyperSizer®, available from Collier Research Corporation of Newport News, Va.; GENESIS, available from Vanderplaats R&D, Inc. of Colorado Springs, Colo.; and the like.

The computer 216 is configured to access results from a finite element analysis of the FEM model that indicate internal loads and deflections on the structural product at the respective nodal points when the structural product is under an external load, and the results are also indexed by element identifier. Similar to the FEM model, the computer or another computer used in the method 200 may in some examples perform the finite element analysis. For this purpose, as well as the post-processing as described below, the computer may benefit from commercially-available software tools. Examples of suitable tools include CATIA and Abaqus, available from Dassault Systèmes S.A.; the ANSYS software suite (Fluent); NASTRAN/PATRAN, available from MSC Software Corporation; SolidWorks (COSMOSworks), COMSOL Multiphysics® (FEMLAB), available from COMSOL Inc. of Burlington, Mass.; GENESIS; Altair Hypermesh and Altair HyperView, available from Altair Engineering, Inc.; NX (Unigraphics), available from Siemens PLM Software of Plano, Tex.; TAK 2000, available from K&K Associates of Westminster, Colo.; Pro/ENGINEER, available from PTC Inc. of Needham, Mass.; LS-DYNA®, available from Livermore Software Technology Corporation (LSTC) of Livermore, Calif.; and the like.

According to example implementations, the computer 216 is configured to identify a part identifier for a component part of the structural product. The computer is configured to determine element identifiers of the elements for the component part, and whose nodal datasets include the part identifier. The computer is configured to extract the internal loads and deflections on the component part from the results, and using the element identifiers; and the computer is configured to post-process the internal loads and deflections on the component part to determine an effect of the external load on the component part. In some examples, the nodal datasets of the elements include the part identifiers, and further include values of one or more properties of the structural product at the elements; and in some of these examples, the results of the finite element analysis indicate the internal loads and deflections determined based on at least some of the values.

In some examples, the computer 216 is configured to produce an output that indicates the effect of the external load on the component part. In some of these examples, the computer is also configured to cause display of the output to facilitate design of the structural product.

In some examples, the computer 216 configured to identify the part identifier includes the computer configured to identify a plurality of the part identifiers for a plurality of the component parts, and the element identifiers are of the elements for the plurality of the component parts. In some of these examples, the internal loads and deflections on the plurality of the component parts ar. The computer is configured to extracted, and the internal loads and deflections on the plurality of the component parts are post-processed to determine the effects of the external load on the plurality of the component parts.

In some further examples, the effect of the external load on the plurality of the component parts is determined according to analysis templates that are specific to types of the component parts. In some of these examples, the computer 216 is configured to determine a plurality of the analysis templates for the types of the plurality of the component parts from the plurality of the part identifiers. The computer is configured to populate the plurality of analysis templates with the internal loads and deflections on the respective ones of the plurality of component parts. The internal loads and deflections on the plurality of the component parts, then, are post-processed using the plurality of analysis templates populated with the internal loads and deflections.

As suggested above, in some examples, the computer 216 is configured to produce an output that indicates the effects of the external load on the plurality of the component parts. And the computer is configured to cause display of the output in which the effects are selectable by component part of the plurality of the component parts.

In some of these examples, the computer 216 configured to post-process the internal loads and deflections includes the computer configured to determine a structural integrity of the component part. In this regard, the computer is configured to determine a distribution of the internal loads and deflections. The computer is configured to predict a failure rate of the component part under the external load from the distribution; and the computer is configured to determine the structural integrity of the component part under the external load from the failure rate.

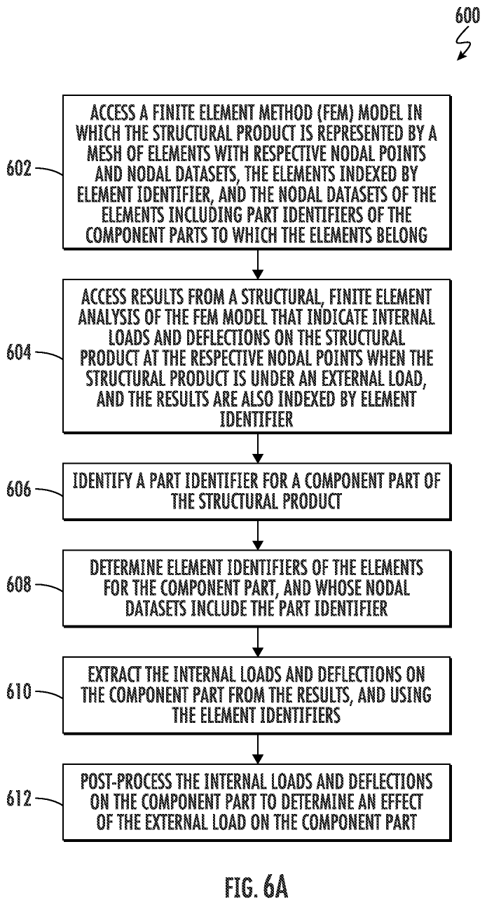

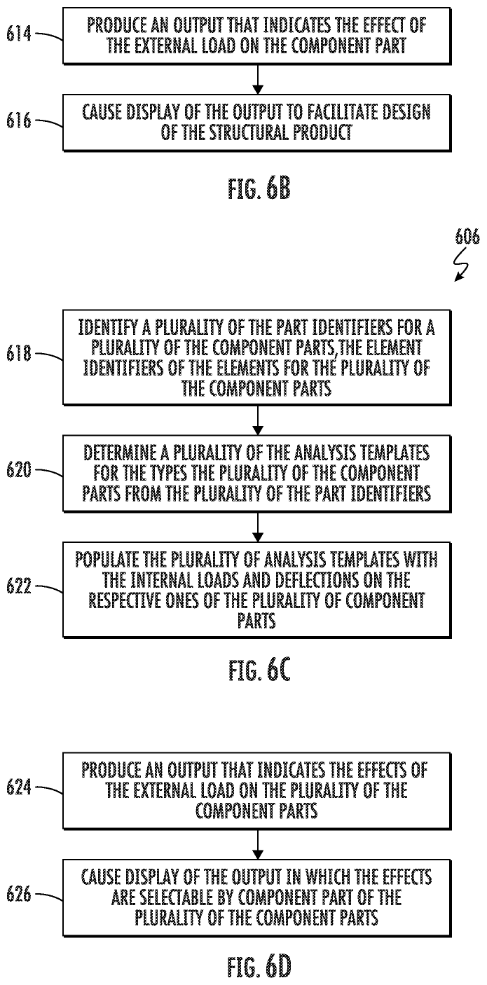

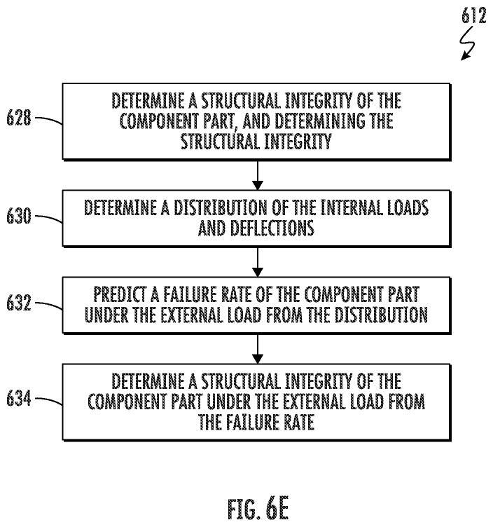

FIGS. 6A-6E are flowcharts illustrating various steps in a method 600 of designing a structural product that includes component parts, according to various example implementations of the present disclosure. The method includes accessing a finite element method (FEM) model in which the structural product is represented by a mesh of elements with respective nodal points and nodal datasets, the elements indexed by element identifier, and the nodal datasets of the elements including part identifiers of the component parts to which the elements belong, as shown at block 602 of FIG. 6A. The method includes accessing results from a finite element analysis of the FEM model that indicate internal loads and deflections on the structural product at the respective nodal points when the structural product is under an external load, and the results are also indexed by element identifier, as shown at block 604. The method includes identifying a part identifier for a component part of the structural product, as shown at block 606. The method includes determining element identifiers of the elements for the component part, and whose nodal datasets include the part identifier, as shown at block 608. The method includes extracting the internal loads and deflections on the component part from the results, and using the element identifiers, as shown at block 610. And the method includes post-processing the internal loads and deflections on the component part to determine an effect of the external load on the component part, as shown at block 612.

In some examples, the method 600 further includes producing an output that indicates the effect of the external load on the component part, as shown at block 614 of FIG. 6B. In some of these examples, method includes causing display of the output to facilitate design of the structural product, as shown at block 616.

In some examples, the nodal datasets of the elements include the part identifiers, and further include values of one or more properties of the structural product at the elements. In some of these examples, the results of the finite element analysis indicate the internal loads and deflections determined based on at least some of the values.

In some examples, identifying the part identifier at block 606 includes identifying a plurality of the part identifiers for a plurality of the component parts, and the element identifiers are of the elements for the plurality of the component parts, as shown at block 618 of FIG. 6C. In some of these examples, the internal loads and deflections on the plurality of the component parts are extracted at block 610, and the internal loads and deflections on the plurality of the component parts are post-processed at block 612 to determine the effects of the external load on the plurality of the component parts.

In some further examples, the effect of the external load on the plurality of the component parts is determined according to analysis templates that are specific to types of the component parts. In some of these further examples, the method 600 further includes determining a plurality of the analysis templates for the types of the plurality of the component parts from the plurality of the part identifiers, as shown at block 620. The method in some of these example also includes populating the plurality of analysis templates with the internal loads and deflections on the respective ones of the plurality of component parts, as shown at block 622.

In some examples, the internal loads and deflections on the plurality of the component parts are post-processed at block 612 using the plurality of analysis templates populated with the internal loads and deflections.

In some examples, the method 600 further includes producing an output that indicates the effects of the external load on the plurality of the component parts as shown at block 624 of FIG. 6D. And the method includes causing display of the output in which the effects are selectable by component part of the plurality of the component parts, as shown at block 626.

In some examples, post-processing the internal loads and deflections at block 612 includes determining a structural integrity of the component part, as shown at block 628 of FIG. 6E. In some of these examples, determining the structural integrity includes determining a distribution of the internal loads and deflections, as shown at block 630. A failure rate of the component part under the external load is predicted from the distribution, as shown at block 632. And the structural integrity of the component part under the external load is determined from the failure rate, as shown at block 634.

Example implementations of the present disclosure may be implemented by various means. These means may include computer hardware, alone or under direction of one or more computer programs from a computer-readable storage medium. In some examples, one or more apparatuses such as one or more of the computers 216-228 may be configured to implement example implementations of the present disclosure. In examples involving more than one apparatus, the respective apparatuses may be connected to or otherwise in communication with one another in a number of different manners, such as directly or indirectly via a wired or wireless network or the like.

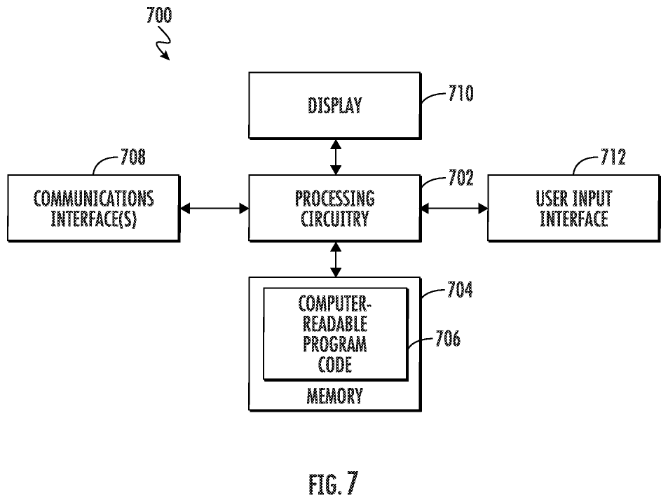

FIG. 7 illustrates an apparatus 700 according to some example implementations of the present disclosure. Generally, an apparatus of exemplary implementations of the present disclosure may comprise, include or be embodied in one or more fixed or portable electronic devices. Examples of suitable electronic devices include a smartphone, tablet computer, laptop computer, desktop computer, workstation computer, server computer or the like. The apparatus may include one or more of each of a number of components such as, for example, processing circuitry 702 (e.g., processor unit) connected to a memory 704 (e.g., storage device).

The processing circuitry 702 may be composed of one or more processors alone or in combination with one or more memories. The processing circuitry is generally any piece of computer hardware that is capable of processing information such as, for example, data, computer programs and/or other suitable electronic information. The processing circuitry is composed of a collection of electronic circuits some of which may be packaged as an integrated circuit or multiple interconnected integrated circuits (an integrated circuit at times more commonly referred to as a “chip”). The processing circuitry may be configured to execute computer programs, which may be stored onboard the processing circuitry or otherwise stored in the memory 704 (of the same or another apparatus).

The processing circuitry 702 may be a number of processors, a multi-core processor or some other type of processor, depending on the particular implementation. Further, the processing circuitry may be implemented using a number of heterogeneous processor systems in which a main processor is present with one or more secondary processors on a single chip. As another illustrative example, the processing circuitry may be a symmetric multi-processor system containing multiple processors of the same type. In yet another example, the processing circuitry may be embodied as or otherwise include one or more ASICs, FPGAs or the like. Thus, although the processing circuitry may be capable of executing a computer program to perform one or more functions, the processing circuitry of various examples may be capable of performing one or more functions without the aid of a computer program. In either instance, the processing circuitry may be appropriately programmed to perform functions or operations according to example implementations of the present disclosure.

The memory 704 is generally any piece of computer hardware that is capable of storing information such as, for example, data, computer programs (e.g., computer-readable program code 706) and/or other suitable information either on a temporary basis and/or a permanent basis. The memory may include volatile and/or non-volatile memory, and may be fixed or removable. Examples of suitable memory include random access memory (RAM), read-only memory (ROM), a hard drive, a flash memory, a thumb drive, a removable computer diskette, an optical disk, a magnetic tape or some combination of the above. Optical disks may include compact disk-read only memory (CD-ROM), compact disk-read/write (CD-R/W), DVD or the like. In various instances, the memory may be referred to as a computer-readable storage medium. The computer-readable storage medium is a non-transitory device capable of storing information, and is distinguishable from computer-readable transmission media such as electronic transitory signals capable of carrying information from one location to another. Computer-readable medium as described herein may generally refer to a computer-readable storage medium or computer-readable transmission medium.

In addition to the memory 704, the processing circuitry 702 may also be connected to one or more interfaces for displaying, transmitting and/or receiving information. The interfaces may include a communications interface 708 (e.g., communications unit) and/or one or more user interfaces. The communications interface may be configured to transmit and/or receive information, such as to and/or from other apparatus(es), network(s) or the like. The communications interface may be configured to transmit and/or receive information by physical (wired) and/or wireless communications links. Examples of suitable communication interfaces include a network interface controller (NIC), wireless NIC (WNIC) or the like.

The user interfaces may include a display 710 and/or one or more user input interfaces 712 (e.g., input/output unit). The display may be configured to present or otherwise display information to a user, suitable examples of which include a liquid crystal display (LCD), light-emitting diode display (LED), plasma display panel (PDP) or the like. The user input interfaces may be wired or wireless, and may be configured to receive information from a user into the apparatus, such as for processing, storage and/or display. Suitable examples of user input interfaces include a microphone, image or video capture device, keyboard or keypad, joystick, touch-sensitive surface (separate from or integrated into a touchscreen), biometric sensor or the like. The user interfaces may further include one or more interfaces for communicating with peripherals such as printers, scanners or the like.

As indicated above, program code instructions may be stored in memory, and executed by processing circuitry that is thereby programmed, to implement functions of the systems, subsystems, tools and their respective elements described herein. As will be appreciated, any suitable program code instructions may be loaded onto a computer or other programmable apparatus from a computer-readable storage medium to produce a particular machine, such that the particular machine becomes a means for implementing the functions specified herein. These program code instructions may also be stored in a computer-readable storage medium that can direct a computer, a processing circuitry or other programmable apparatus to function in a particular manner to thereby generate a particular machine or particular article of manufacture. The instructions stored in the computer-readable storage medium may produce an article of manufacture, where the article of manufacture becomes a means for implementing functions described herein. The program code instructions may be retrieved from a computer-readable storage medium and loaded into a computer, processing circuitry or other programmable apparatus to configure the computer, processing circuitry or other programmable apparatus to execute operations to be performed on or by the computer, processing circuitry or other programmable apparatus.

Retrieval, loading and execution of the program code instructions may be performed sequentially such that one instruction is retrieved, loaded and executed at a time. In some example implementations, retrieval, loading and/or execution may be performed in parallel such that multiple instructions are retrieved, loaded, and/or executed together. Execution of the program code instructions may produce a computer-implemented process such that the instructions executed by the computer, processing circuitry or other programmable apparatus provide operations for implementing functions described herein.

Execution of instructions by a processing circuitry, or storage of instructions in a computer-readable storage medium, supports combinations of operations for performing the specified functions. In this manner, an apparatus 700 may include a processing circuitry 702 and a computer-readable storage medium or memory 704 coupled to the processing circuitry, where the processing circuitry is configured to execute computer-readable program code 706 stored in the memory. It will also be understood that one or more functions, and combinations of functions, may be implemented by special purpose hardware-based computer systems and/or processing circuitry which perform the specified functions, or combinations of special purpose hardware and program code instructions.

As explained above and reiterated below, the present disclosure includes, without limitation, the following example implementations.

Clause 1. An apparatus for designing a structural product that includes component parts, the apparatus comprising: a memory configured to store computer-readable program code; and processing circuitry configured to access the memory, and execute the computer-readable program code to cause the apparatus to at least: access a finite element method (FEM) model in which the structural product is represented by a mesh of elements with respective nodal points and nodal datasets, the elements indexed by element identifier, and the nodal datasets of the elements including part identifiers of the component parts to which the elements belong; access results from a finite element analysis of the FEM model that indicate internal loads and deflections on the structural product at the respective nodal points when the structural product is under an external load, and the results are also indexed by element identifier; identify a part identifier for a component part of the structural product; determine element identifiers of the elements for the component part, and whose nodal datasets include the part identifier; extract the internal loads and deflections on the component part from the results, and using the element identifiers; and post-process the internal loads and deflections on the component part to determine an effect of the external load on the component part.

Clause 2. The apparatus of clause 1, wherein the processing circuitry is configured to execute the computer-readable program code to cause the apparatus to further at least: produce an output that indicates the effect of the external load on the component part; and cause display of the output to facilitate design of the structural product.

Clause 3. The apparatus of clause 1 or clause 2, wherein the nodal datasets of the elements include the part identifiers, and further include values of one or more properties of the structural product at the elements, the results of the finite element analysis indicate the internal loads and deflections determined based on at least some of the values.

Clause 4. The apparatus of any of clauses 1 to 3, wherein the apparatus caused to identify the part identifier includes the apparatus caused to identify a plurality of the part identifiers for a plurality of the component parts, and the element identifiers are of the elements for the plurality of the component parts, and wherein the internal loads and deflections on the plurality of the component parts are extracted, and the internal loads and deflections on the plurality of the component parts are post-processed to determine the effects of the external load on the plurality of the component parts.

Clause 5. The apparatus of clause 4, wherein the effect of the external load on the plurality of the component parts is determined according to analysis templates that are specific to types of the component parts, and the processing circuitry is configured to execute the computer-readable program code to cause the apparatus to further at least: determine a plurality of the analysis templates for the types of the plurality of the component parts from the plurality of the part identifiers; populate the plurality of analysis templates with the internal loads and deflections on the respective ones of the plurality of component parts, and wherein the internal loads and deflections on the plurality of the component parts are post-processed using the plurality of analysis templates populated with the internal loads and deflections.

Clause 6. The apparatus of clause 4 or clause 5, wherein the processing circuitry is configured to execute the computer-readable program code to cause the apparatus to further at least: produce an output that indicates the effects of the external load on the plurality of the component parts; and cause display of the output in which the effects are selectable by component part of the plurality of the component parts.

Clause 7. The apparatus of any of clauses 1 to 6, wherein the apparatus caused to post-process the internal loads and deflections includes the apparatus caused to determine a structural integrity of the component part, and determining the structural integrity includes at least: determine a distribution of the internal loads and deflections; predict a failure rate of the component part under the external load from the distribution; and determine the structural integrity of the component part under the external load from the failure rate.

Clause 8. A method of designing a structural product that includes component parts, the method comprising: accessing a finite element method (FEM) model in which the structural product is represented by a mesh of elements with respective nodal points and nodal datasets, the elements indexed by element identifier, and the nodal datasets of the elements including part identifiers of the component parts to which the elements belong; accessing results from a finite element analysis of the FEM model that indicate internal loads and deflections on the structural product at the respective nodal points when the structural product is under an external load, and the results are also indexed by element identifier; identifying a part identifier for a component part of the structural product; determining element identifiers of the elements for the component part, and whose nodal datasets include the part identifier; extracting the internal loads and deflections on the component part from the results, and using the element identifiers; and post-processing the internal loads and deflections on the component part to determine an effect of the external load on the component part.

Clause 9. The method of clause 8, wherein the method further comprises: producing an output that indicates the effect of the external load on the component part; and causing display of the output to facilitate design of the structural product.

Clause 10. The method of clause 8 or clause 9, wherein the nodal datasets of the elements include the part identifiers, and further include values of one or more properties of the structural product at the elements, the results of the finite element analysis indicate the internal loads and deflections determined based on at least some of the values.

Clause 11. The method of any of clauses 8 to 10, wherein identifying the part identifier includes identifying a plurality of the part identifiers for a plurality of the component parts, and the element identifiers are of the elements for the plurality of the component parts, and wherein the internal loads and deflections on the plurality of the component parts are extracted, and the internal loads and deflections on the plurality of the component parts are post-processed to determine the effects of the external load on the plurality of the component parts.

Clause 12. The method of clause 11, wherein the effect of the external load on the plurality of the component parts is determined according to analysis templates that are specific to types of the component parts, and the method further comprises: determining a plurality of the analysis templates for the types of the plurality of the component parts from the plurality of the part identifiers; populating the plurality of analysis templates with the internal loads and deflections on the respective ones of the plurality of component parts, and wherein the internal loads and deflections on the plurality of the component parts are post-processed using the plurality of analysis templates populated with the internal loads and deflections.

Clause 13. The method of clause 11 or clause 12, wherein the method further comprises: producing an output that indicates the effects of the external load on the plurality of the component parts; and causing display of the output in which the effects are selectable by component part of the plurality of the component parts.

Clause 14. The method of any of clauses 8 to 13, wherein post-processing the internal loads and deflections includes determining a structural integrity of the component part, and determining the structural integrity includes at least: determining a distribution of the internal loads and deflections; predicting a failure rate of the component part under the external load from the distribution; and determining the structural integrity of the component part under the external load from the failure rate.

Clause 15. A computer-readable storage medium for designing a structural product that includes component parts, the computer-readable storage medium being non-transitory and having computer-readable program code stored therein that, in response to execution by processing circuitry, causes an apparatus to at least: access a finite element method (FEM) model in which the structural product is represented by a mesh of elements with respective nodal points and nodal datasets, the elements indexed by element identifier, and the nodal datasets of the elements including part identifiers of the component parts to which the elements belong; access results from a finite element analysis of the FEM model that indicate internal loads and deflections on the structural product at the respective nodal points when the structural product is under an external load, and the results are also indexed by element identifier; identify a part identifier for a component part of the structural product; determine element identifiers of the elements for the component part, and whose nodal datasets include the part identifier; extract the internal loads and deflections on the component part from the results, and using the element identifiers; and post-process the internal loads and deflections on the component part to determine an effect of the external load on the component part.

Clause 16. The computer-readable storage medium of clause 15, wherein the computer-readable storage medium has further computer-readable program code stored therein that, in response to execution by the processing circuitry, causes the apparatus to further at least: produce an output that indicates the effect of the external load on the component part; and cause display of the output to facilitate design of the structural product.

Clause 17. The computer-readable storage medium of clause 15 or clause 16, wherein the nodal datasets of the elements include the part identifiers, and further include values of one or more properties of the structural product at the elements, the results of the finite element analysis indicate the internal loads and deflections determined based on at least some of the values.

Clause 18. The computer-readable storage medium of any of clauses 15 to 17, wherein the apparatus caused to identify the part identifier includes the apparatus caused to identify a plurality of the part identifiers for a plurality of the component parts, and the element identifiers are of the elements for the plurality of the component parts, and wherein the internal loads and deflections on the plurality of the component parts are extracted, and the internal loads and deflections on the plurality of the component parts are post-processed to determine the effects of the external load on the plurality of the component parts.

Clause 19. The computer-readable storage medium of clause 18, wherein the effect of the external load on the plurality of the component parts is determined according to analysis templates that are specific to types of the component parts, and the computer-readable storage medium has further computer-readable program code stored therein that, in response to execution by the processing circuitry, causes the apparatus to further at least: determine a plurality of the analysis templates for the types of the plurality of the component parts from the plurality of the part identifiers; populate the plurality of analysis templates with the internal loads and deflections on the respective ones of the plurality of component parts, and wherein the internal loads and deflections on the plurality of the component parts are post-processed using the plurality of analysis templates populated with the internal loads and deflections.

Clause 20. The computer-readable storage medium of clause 18 or clause 19, wherein the computer-readable storage medium has further computer-readable program code stored therein that, in response to execution by the processing circuitry, causes the apparatus to further at least: produce an output that indicates the effects of the external load on the plurality of the component parts; and cause display of the output in which the effects are selectable by component part of the plurality of the component parts.

Clause 21. The computer-readable storage medium of any of clauses 15 to 20, wherein the apparatus caused to post-process the internal loads and deflections includes the apparatus caused to determine a structural integrity of the component part, and determining the structural integrity includes at least: determine a distribution of the internal loads and deflections; predict a failure rate of the component part under the external load from the distribution; and determine the structural integrity of the component part under the external load from the failure rate.

Many modifications and other implementations of the disclosure set forth herein will come to mind to one skilled in the art to which the disclosure pertains having the benefit of the teachings presented in the foregoing description and the associated figures. Therefore, it is to be understood that the disclosure is not to be limited to the specific implementations disclosed and that modifications and other implementations are intended to be included within the scope of the appended claims. Moreover, although the foregoing description and the associated figures describe example implementations in the context of certain example combinations of elements and/or functions, it should be appreciated that different combinations of elements and/or functions may be provided by alternative implementations without departing from the scope of the appended claims. In this regard, for example, different combinations of elements and/or functions than those explicitly described above are also contemplated as may be set forth in some of the appended claims. Although specific terms are employed herein, they are used in a generic and descriptive sense only and not for purposes of limitation.

What is claimed is:

1. An apparatus for designing a structural product that includes component parts, the apparatus comprising:
a memory configured to store computer-readable program code; and
processing circuitry configured to access the memory, and execute the computer-readable program code to cause the apparatus to at least:
access a finite element method (FEM) model in which the structural product is represented by a mesh of elements with respective nodal points and nodal datasets, the elements indexed by element identifier, and the nodal datasets of the elements including part identifiers of the component parts to which the elements belong;
access results from a finite element analysis of the FEM model that indicate internal loads and deflections on the structural product at the respective nodal points when the structural product is under an external load, and the results are also indexed by element identifier;
identify a part identifier for a component part of the structural product;
determine element identifiers of the elements for the component part, and whose nodal datasets include the part identifier;
extract the internal loads and deflections on the component part from the results, and using the element identifiers; and
post-process the internal loads and deflections on the component part to determine an effect of the external load on the component part.

2. The apparatus of claim 1, wherein the processing circuitry is configured to execute the computer-readable program code to cause the apparatus to further at least:
produce an output that indicates the effect of the external load on the component part; and
cause display of the output to facilitate design of the structural product.

3. The apparatus of claim 1, wherein the nodal datasets of the elements include the part identifiers, and further include values of one or more properties of the structural product at the elements, the results of the finite element analysis indicate the internal loads and deflections determined based on at least some of the values.

4. The apparatus of claim 1, wherein the apparatus caused to identify the part identifier includes the apparatus caused to identify a plurality of the part identifiers for a plurality of the component parts, and the element identifiers are of the elements for the plurality of the component parts, and
wherein the internal loads and deflections on the plurality of the component parts are extracted, and the internal loads and deflections on the plurality of the component parts are post-processed to determine the effects of the external load on the plurality of the component parts.

5. The apparatus of claim 4, wherein the effect of the external load on the plurality of the component parts is determined according to analysis templates that are specific to types of the component parts, and the processing circuitry is configured to execute the computer-readable program code to cause the apparatus to further at least:
determine a plurality of the analysis templates for the types of the plurality of the component parts from the plurality of the part identifiers;
populate the plurality of analysis templates with the internal loads and deflections on the respective ones of the plurality of component parts, and
wherein the internal loads and deflections on the plurality of the component parts are post-processed using the plurality of analysis templates populated with the internal loads and deflections.

6. The apparatus of claim 4, wherein the processing circuitry is configured to execute the computer-readable program code to cause the apparatus to further at least:
produce an output that indicates the effects of the external load on the plurality of the component parts; and
cause display of the output in which the effects are selectable by component part of the plurality of the component parts.

7. The apparatus of claim 1, wherein the apparatus caused to post-process the internal loads and deflections includes the apparatus caused to determine a structural integrity of the component part, and determining the structural integrity includes at least:
determine a distribution of the internal loads and deflections;
predict a failure rate of the component part under the external load from the distribution; and
determine the structural integrity of the component part under the external load from the failure rate.

8. A method of designing a structural product that includes component parts, the method comprising:
accessing a finite element method (FEM) model in which the structural product is represented by a mesh of elements with respective nodal points and nodal datasets, the elements indexed by element identifier, and the nodal datasets of the elements including part identifiers of the component parts to which the elements belong;
accessing results from a finite element analysis of the FEM model that indicate internal loads and deflections on the structural product at the respective nodal points when the structural product is under an external load, and the results are also indexed by element identifier;
identifying a part identifier for a component part of the structural product;
determining element identifiers of the elements for the component part, and whose nodal datasets include the part identifier;
extracting the internal loads and deflections on the component part from the results, and using the element identifiers; and
post-processing the internal loads and deflections on the component part to determine an effect of the external load on the component part.

9. The method of claim 8, wherein the method further comprises:
producing an output that indicates the effect of the external load on the component part; and
causing display of the output to facilitate design of the structural product.

10. The method of claim 8, wherein the nodal datasets of the elements include the part identifiers, and further include values of one or more properties of the structural product at the elements, the results of the finite element analysis indicate the internal loads and deflections determined based on at least some of the values.

11. The method of claim 8, wherein identifying the part identifier includes identifying a plurality of the part identifiers for a plurality of the component parts, and the element identifiers are of the elements for the plurality of the component parts, and
wherein the internal loads and deflections on the plurality of the component parts are extracted, and the internal loads and deflections on the plurality of the component parts are post-processed to determine the effects of the external load on the plurality of the component parts.

12. The method of claim 11, wherein the effect of the external load on the plurality of the component parts is determined according to analysis templates that are specific to types of the component parts, and the method further comprises:
determining a plurality of the analysis templates for the types of the plurality of the component parts from the plurality of the part identifiers;
populating the plurality of analysis templates with the internal loads and deflections on the respective ones of the plurality of component parts, and
wherein the internal loads and deflections on the plurality of the component parts are post-processed using the plurality of analysis templates populated with the internal loads and deflections.

13. The method of claim 11, wherein the method further comprises:
producing an output that indicates the effects of the external load on the plurality of the component parts; and
causing display of the output in which the effects are selectable by component part of the plurality of the component parts.

14. The method of claim 8, wherein post-processing the internal loads and deflections includes determining a structural integrity of the component part, and determining the structural integrity includes at least:
determining a distribution of the internal loads and deflections;
predicting a failure rate of the component part under the external load from the distribution; and
determining the structural integrity of the component part under the external load from the failure rate.

15. A computer-readable storage medium for designing a structural product that includes component parts, the computer-readable storage medium being non-transitory and having computer-readable program code stored therein that, in response to execution by processing circuitry, causes an apparatus to at least:
access a finite element method (FEM) model in which the structural product is represented by a mesh of elements with respective nodal points and nodal datasets, the elements indexed by element identifier, and the nodal datasets of the elements including part identifiers of the component parts to which the elements belong;
access results from a finite element analysis of the FEM model that indicate internal loads and deflections on the structural product at the respective nodal points when the structural product is under an external load, and the results are also indexed by element identifier;
identify a part identifier for a component part of the structural product;
determine element identifiers of the elements for the component part, and whose nodal datasets include the part identifier;
extract the internal loads and deflections on the component part from the results, and using the element identifiers; and
post-process the internal loads and deflections on the component part to determine an effect of the external load on the component part.

16. The computer-readable storage medium of claim 15, wherein the computer-readable storage medium has further computer-readable program code stored therein that, in response to execution by the processing circuitry, causes the apparatus to further at least:
produce an output that indicates the effect of the external load on the component part; and
cause display of the output to facilitate design of the structural product.

17. The computer-readable storage medium of claim 15, wherein the nodal datasets of the elements include the part identifiers, and further include values of one or more properties of the structural product at the elements, the results of the finite element analysis indicate the internal loads and deflections determined based on at least some of the values.

18. The computer-readable storage medium of claim 15, wherein the apparatus caused to identify the part identifier includes the apparatus caused to identify a plurality of the part identifiers for a plurality of the component parts, and the element identifiers are of the elements for the plurality of the component parts, and
wherein the internal loads and deflections on the plurality of the component parts are extracted, and the internal loads and deflections on the plurality of the component parts are post-processed to determine the effects of the external load on the plurality of the component parts.

19. The computer-readable storage medium of claim 18, wherein the effect of the external load on the plurality of the component parts is determined according to analysis templates that are specific to types of the component parts, and the computer-readable storage medium has further computer-readable program code stored therein that, in response to execution by the processing circuitry, causes the apparatus to further at least:
determine a plurality of the analysis templates for the types of the plurality of the component parts from the plurality of the part identifiers;
populate the plurality of analysis templates with the internal loads and deflections on the respective ones of the plurality of component parts, and
wherein the internal loads and deflections on the plurality of the component parts are post-processed using the plurality of analysis templates populated with the internal loads and deflections.

20. The computer-readable storage medium of claim 18, wherein the computer-readable storage medium has further computer-readable program code stored therein that, in response to execution by the processing circuitry, causes the apparatus to further at least:
produce an output that indicates the effects of the external load on the plurality of the component parts; and
cause display of the output in which the effects are selectable by component part of the plurality of the component parts.

21. The computer-readable storage medium of claim 15, wherein the apparatus caused to post-process the internal loads and deflections includes the apparatus caused to determine a structural integrity of the component part, and determining the structural integrity includes at least:
determine a distribution of the internal loads and deflections;
predict a failure rate of the component part under the external load from the distribution; and
determine the structural integrity of the component part under the external load from the failure rate.
